(19) United States
(12) Patent Application Publication
(10) Pub. No.: US 2025/0291583 A1
(43) Pub. Date: Sep. 18, 2025

(54) AUTOMATED AI-DRIVEN SOFTWARE DEVELOPMENT

(71) Applicant: MICROSOFT TECHNOLOGY LICENSING, LLC., REDMOND, WA (US)

(72) Inventors: ANISHA AGARWAL, BOSTON, MA (US); NEELAKANTAN SUNDARESAN, BELLEVUE, WA (US); MICHELE TUFANO, BELLEVUE, WA (US); ROSHANAK ZILOUCHIAN MOGHADDAM, KIRKLAND, WA (US)

(21) Appl. No.: 18/741,720

(22) Filed: Jun. 12, 2024

Related U.S. Application Data
(60) Provisional application No. 63/564,158, filed on Mar. 12, 2024.

(51) Int. Cl. G06F 8/70; G06F 21/53

(52) U.S. Cl. CPC G06F 8/70; G06F 21/53

(57) ABSTRACT

An automated AI-driven software development system utilizes generative neural models to determine the commands needed to execute a software engineering task. The system uses a conversation manager that manages conversations between an AI-autonomous environment and a codebase environment to determine the operations needed to complete a software engineering task until all operations complete. The AI-autonomous environment utilizes the AI-agents coupled to the generative neural models to determine the commands needed to achieve a user task and any follow-on tasks needed to ensure that the user task works as intended. The codebase environment performs the operations needed for the user task in a secure execution environment with access to the user's codebase.

### CROSS-REFERENCE TO RELATED APPLICATION

The present application claims the benefit of the earlier filed provisional application having Ser. No. 63/564,158, filed on Mar. 12, 2024, entitled “Automated AI Development,” which is incorporated by reference in its entirety.

### BACKGROUND

The development of a software application is a lengthy and complicated process that consists of numerous tasks, such as planning, designing, programming, testing, documentation and maintenance. Often a developer uses an integrated development environment (IDE) to assist in the generation of the software application. The IDE contains tools that enable the developer to design, build, program, test and maintain the software application. The IDE contains editors, parsers, compilers, debuggers, code libraries, build tools, etc. However, to develop the software application, the developer initiates each step in the development process separately and analyzes the output from each step to determine the next step to complete the task.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A fully-automated Artificial Intelligence (AI)-driven software development system provides for autonomous planning and execution of intricate software engineering tasks. The system enables users to define complex tasks which are assigned to autonomous AI-agents to achieve. These AI-agents interact with a generative neural model to determine the commands to perform on a user codebase, including, but not limited to, file editing, retrieval, build processes, execution, testing, and GIT operations. The system establishes a secure development environment by confining the execution of all operations within a secure execution environment. The system incorporates guardrails to ensure user privacy and file security, allowing users to define specific permitted or restricted actions and operations.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary AI-driven software development system.

FIG. 2 is a schematic diagram of an exemplary Yet Another Markup Language (YAML) file used to configure the rules and actions of an AI-agent.

FIG. 3 is a flow diagram illustrating an exemplary method of the AI-driven software development system.

FIGS. 4A-4B illustrate an exemplary autonomous flow of the AI-driven software development system for an exemplary task.

FIG. 5 is a block diagram illustrating an exemplary operating environment.

### DETAILED DESCRIPTION

Aspects of the present disclosure pertain to the autonomous processing of a software engineering task without manual intervention. A software engineering task comprises a sequence of operations to be performed to generate, build, test, or maintain software, such as without limitation, code generation, code design, code documentation generation, code completion, software bug classification, software bug repair, software vulnerability detection, software vulnerability correction, application build, software optimization, software testing, code maintenance, and combinations thereof.

An AI-driven software development system comprises an AI-automation environment, a codebase environment, and a conversation manager. The conversation manager manages the conversation between the AI-automation environment and the codebase environment. A conversation is the list of messages or communications between the AI-automation environment and the codebase environment during the autonomous processing of the software engineering task.

The AI-automation environment includes AI-agents configured to interact with various types of generative neural models to determine the command to execute that processes the given software engineering task on a user codebase. The codebase environment executes the command on the user codebase in a secure execution environment. The status and output from the execution of the command is forwarded to the conversation manager.

The conversation manager engages with the AI-agents continuously over numerous iterations until a stop command is generated as the next command to execute which terminates the processing. At an initial iteration, the conversation manager engages an AI-agent to provide an initial command to execute and the codebase environment executes the initial command. The conversation manager engages the AI-agents at a next iteration for a follow-on command to execute based on the current state of the conversation which includes the status of the initial command execution. The follow-on command is executed in the secure execution environment with access to the user codebase. This process continues until at the last iteration an AI-agent responds with a stop command.

Attention now turns to a more detailed description of the components, methods, processes, and system for AI-driven software development.

### System

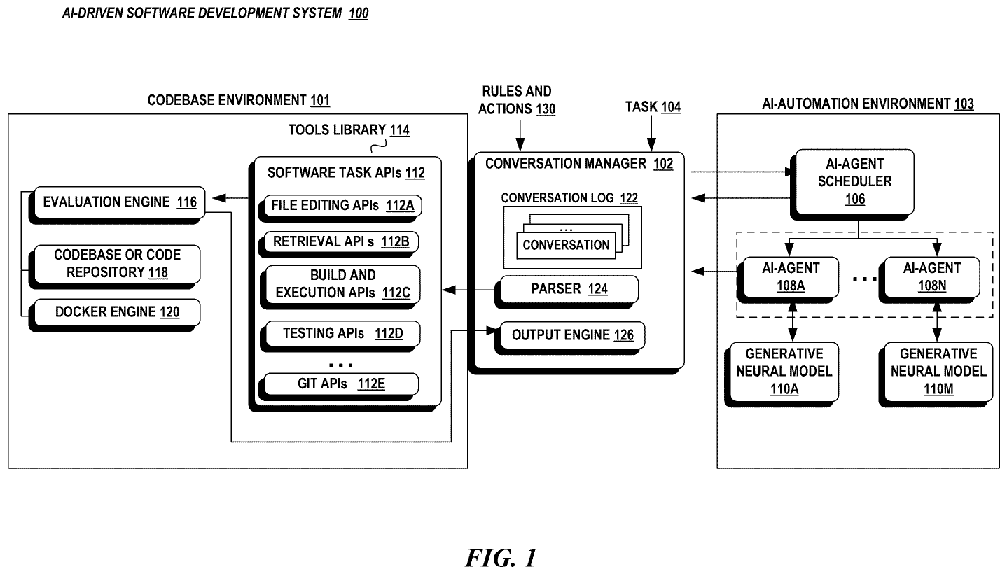

FIG. 1 illustrates a block diagram of an exemplary automated AI-driven software development system 100. The system 100 includes a conversation manager 102 that manages the ongoing conversation between a codebase environment 101 and an AI-automated environment 103 to perform a software engineering task autonomously. The codebase environment 101 includes a tools library, an evaluation engine 116, a code repository or codebase 118, and a docker engine 120. The AI-automated environment 103 includes an AI-scheduler 106 and several AI-agents 108A-108N, with each AI-agent 108A-108N communicatively coupled to a particular generative neural model 110A-110M. The conversation manager 102 includes a conversation log 122 of conversations, a parser 124, and an output engine 126.

A conversation is a list of messages between the conversation manager 102, the AI-automated environment 103 and the codebase environment 101 used to perform a software engineering task. The conversation manager 102 starts with receiving a software engineering task or task 104 from a user and interacts with the AI-automated environment 103 and the codebase environment 101 to identify the commands needed to complete the task. The conversation manager iteratively generates messages with the AI-automated environment 103 and the codebase environment 101 until the task is completed or the user or the conversation manager decides to interrupt the process.

The conversation manager 102 interacts with an AI-agent scheduler 106 to obtain from one or more AI-agents the sequence of commands and operations to be executed on a user codebase in order to achieve the user task. The AI-agent scheduler 106 schedules one or more AI-agents 108A-108N (“108”) to interact with a generative neural model 110A-110M (“110”) for the generative neural model to infer or generate a message (i.e., a natural language sentence or a command to be executed on the user's codebase or repository) representing a step towards achieving the user task. The conversation manager 102 inserts the user task as the first message within the conversation, which is then forwarded to the AI-agent scheduler 106, which assigns the conversation, serving as a prompt, to one of the AI-agents. The conversation manager 102 maintains a conversation log 122 for the task which includes the messages to and from the AI-agents and the results from execution of a command.

The conversation manager 102 extracts the command inferred by the generative neural model 110 from a text message sent by an AI-agent 108, and invokes a software task API 112 corresponding to the command. The software task API 112 facilitates the actions needed to execute the command. A command is designed to encapsulate complex actions, tools, and utilities behind a command structure. The software task API 112 is part of a tools library 114 which contains APIs for several software engineering tasks. In an aspect, the software task APIs include a file edit API 112A, a retrieval API 112B, a build and execution API 112C, a testing API 112D, and a GIT API 112E.

The file edit API 112A encompasses commands for editing files, includes code, configuration, and documentation. The utilities within this category, such as write, edit, insert, and delete, offer varying levels of granularity. The AI-agents 108 are associated with actions ranging from writing entire files to modifying specific lines within a file. For example, the command write <file path><start_line>-<end_line><content>, allows the system to re-write a range of lines with new content.

The retrieval API 112B performs various functions from basic Command Language Interface (CLI) tools like grep, find, and ls to more sophisticated embedding-based techniques. An embedding-based technique uses an embedding of a target code snippet to retrieve closely matching embeddings of code snippets from a codebase. The embedding is a real-value vector representation of the code snippet typically generated from an encoder.

The build and execution API 112C allows the system to compute, build, and execute code in a codebase. The testing API 112D enables the system to test code in the codebase by executing a single test case, a specific test file or an entire test suite. The testing API 112D encompasses validation tools such as liners and bug-finding utilities. The GIT API 112E performs the actions needed to perform operations on a version-controlled source code repository (i.e., pull request, merge, commit, etc.).

The evaluation engine 116 interacts with a docker engine 118 and a code repository or codebase 120. The docker engine 118 provides a secure execution environment within which the execution of the software task API is executed isolated from the rest of the system.

The evaluation engine 116 interacts with the code repository or codebase 120 to access programming artifacts needed to execute the task. In an aspect, the code repository 118 is a file archive and web hosting facility that stores large amounts of artifacts, such as source code files, test files, script files, etc. Programmers (i.e., developers, users, end users, etc.) often utilize a shared code repository 118 to store source code and other programming artifacts that can be shared among different programmers. A programming artifact is a file that is produced from a programming activity, such as source code, program configuration data, documentation, tests, execution scripts, and the like. The shared code repository 106 may be configured as a source control system or version control system that stores each version of an artifact, such as a source code file, and tracks the changes or differences between the different versions.

The conversation manager 102 includes a conversation log 122, a parser 124, and an output engine 126. The conversation manager 102 forwards a conversation which serves as a prompt for a generative neural model 110 to determine the possible sequence of commands needed to perform a task. The AI-agent scheduler 106 schedules an appropriate AI-agent to issue the prompt to the generative neural model and to obtain a response. The response is returned to the conversation manager 102. The parser 124 extracts the command from the response and invokes an appropriate software task API which the evaluation engine 116 executes in a docker engine 120. The status of the execution of the software task API and its output is returned to the output engine 126.

The conversation manager 102 updates the conversation by appending the response from the AI-agent, the status of the execution of the software task API and its output in a conversation log. The conversation includes all the messages created and received by the conversation manager to facilitate the task. These messages include the initial user task provided, the AI-agent messages, the execution status of each invoked software task API and the corresponding output.

In an aspect, the generative neural model 110 is a neural transformer model with attention. A neural transformer model with attention is one distinct type of machine learning model. Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. Neural transformers models are one type of deep learning that utilizes an attention mechanism. Attention directs the neural network to focus on a subset of features or tokens in an input sequence thereby learning different representations from the different positions of the tokens in an input sequence. The neural transformer model handles dependencies between its input and output with attention and without using recurrent neural networks (RNN) (e.g., long short-term memory (LSTM) network) and convolutional neural networks (CNN).

There are various configurations of a neural transformer model with attention. In an aspect, the large language model is configured as an encoder-decoder neural transformer model with attention having a series of stacked encoder blocks coupled to a series of stacked decoder blocks. In another aspect, the large language model consists only of stacked decoder blocks. In addition, the large language model may be trained to perform different tasks and/or may be configured in different model sizes (i.e., different number of parameters).

In an aspect, the large language model is pre-trained on natural language text. The training of a large language model requires a considerable amount of training data and computing resources which makes it impossible for some developers to create their own models. The large language model consists of billions of parameters (e.g., weights, biases, embeddings) from being trained on terabytes of data. Examples of the large language models include the pre-trained generative neural transformer models with attention offered by OpenAI i.e., ChatGPT and Codex models, PaLM and Chinchilla by Google, and LLaMa by Meta.

Alternatively, the generative neural model may be a small language model trained on smaller amounts of data and have a smaller size so that they can be deployed in a cellular phone device. These small language models are trained for a dedicated task, such as code completion, code generation, software bug detection, software bug repair, documentation generation, and the like. Examples of small language models include Microsoft's Phi-3-mini models which have between 3.8 billion to 14 billion of parameters.

The conversation manager 102 receives rules and actions 130 from a user which are used to configure the AI-agents. Each AI-agent is configured with permissions and capabilities indicated by the rules and actions provided by a user. For example, the rules are natural language instructions provided to the AI-agent, which are intended to condition their behavior to follow specific patterns. For example, an AI-agent receives natural language instructions to be a developer whose intent is to accomplish user tasks without performing any malicious tasks on the codebase. The actions are a list of operations or APIs which can be invoked to accomplish tasks,

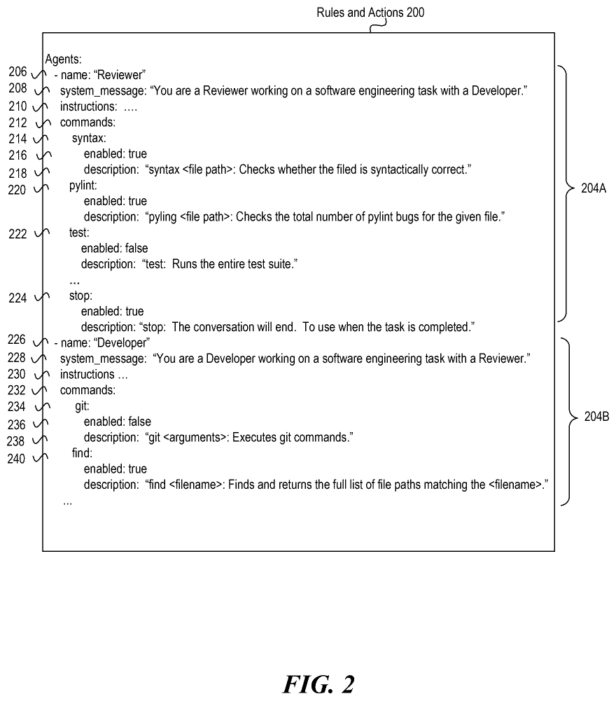

Attention now turns to a more detailed explanation of the configuration of the AI-agents. Turning to FIG. 2, there is shown an exemplary configuration of the rules and actions for the AI-agents 200. In an aspect, the rules and actions are specified in a Yet Another Markup Language (YAML) file shown in FIG. 2.

The YAML file defines the available actions that an AI-agent can initiate. Users can leverage the default settings or fine-grained permissions by enabling or disabling specific actions thereby tailoring the system to a specific configuration. The user can define the number and behavior of the AI-agents, assign specific responsibilities, permissions and available actions.

The configuration shown in FIG. 2 contains a Reviewer AI-agent 204A and a Developer AI-agent 204B. Each AI-agent 204A-204B contains a name 206, 226, a system message 208, 228, instructions 210, 230, and actions 212, 232. The name 206, 226 identifies the role of the AI-agent, the system message 208, 228 specifies the behavior of the agent, the instructions 210, 230 indicate the high-level instructions the AI-agent needs to follow in natural language, and the actions 212, 232 are the operations that the AI-agent can initiate. The system prompt, instructions, and available actions will be provided to each individual agent as the first part of their prompt, followed by the task, and the rest of the conversation. With each action, there is an enabled field 216, 236 which contains either a true or false value. The true value indicates that action is enabled and the false value disengages the action. The enabled field is set by the user.

The Reviewer AI-agent 204A is used to facilitate the actions used to review source code generated by a developer. The actions 212 associated with the Reviewer AI-agent includes syntax, pylint, and test which pertain to ensuring that the developed code is syntactically-correct, fails to contain software bugs, and passes all test cases. The stop action 224 is used by the Reviewer AI-agent to signal to the conversation manager to cease processing when the task is completed.

The Developer AI-agent 204B is used to facilitate actions of a developer in developing source code. The actions associated with this agent include git and find, where git pertains to executing git commands that perform operations on a version-controlled source code repository and find pertains to obtaining software assets from a codebase, project or source code repository. It should be noted that the list of AI-Agents shown in FIG. 2 is extensible and should not be constructed to limiting the techniques disclosed herein.

### Methods

Attention now turns to a more detailed description of the methods used in the system for code review generation. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

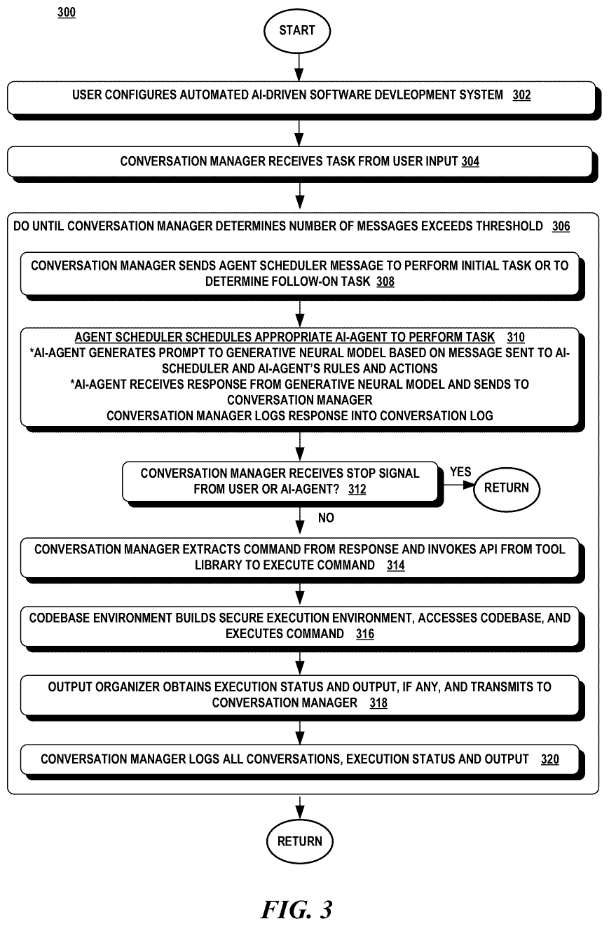

FIG. 3 illustrates an exemplary method of the AI-driven software development system 300. Initially, the user (i.e., developer, customer, programmer) of the system configures the AI-agents by inputting the rules and actions to the conversation manager (block 302). In an aspect, the rules and actions are submitted in an YAML file. The conversation manager reads the YAML file and constructs the number of AI-agents listed in the YAML file and configures their behavior as described therein. In an aspect, each AI-agent is configured to perform a select software engineering task using the user-defined rules and actions. The actions indicate the operations needed to perform the task and the rules represent the AI-agent's behavior in terms of its system prompt and own instructions. The system prompt is a way to provide the generative neural model with context, instructions and guidelines before presenting the generative neural model with a question or the task.

Upon completion of the configuration of the AI-agents, the conversation manager receives a task from a user (block 304). The conversation manager instantiates a conversation containing, initially, only the user task. The conversation is then dispatched to the AI-agent scheduler. The AI-agent scheduler determines the AI-agent to be invoked, and the appropriate AI-agent constructs a prompt to a generative neural model. The prompt includes: (i) the AI-agent's system prompt, (ii) the AI-agent's instructions, (iii) the AI-agent's actions, (iv) the entire conversation which initially will include only the user task (block 308).

During the execution, the conversation includes all previous messages by the AI-agents and codebase environment involved for the completion of the user task (block 308). The transactions with a generative neural model are through a stateless protocol where the generative neural model responds based on the current state or data contained in a prompt. Typically, a task spans several messages or steps and the generative neural model does not retain any information from a previous prompt. For this reason, the conversation manager logs all messages to and from the AI-agents and the codebase environment.

The conversation manager transmits the conversation to the AI-agent scheduler which selects an appropriate AI-agent to handle the conversation at that step (block 310). The AI-agent scheduler may select an AI-agent based on the functions that the AI-agent has enabled. Alternatively, the AI-agent scheduler may utilize a scheduling algorithm, such as round robin scheduling, and priority scheduling to assign the task to a particular AI-agent. In round robin scheduling, a task is assigned to an AI-agent in a preconfigured order. In priority scheduling, each AI-agent is assigned with a priority, and the AI-scheduler assigns the conversation to the AI-agent with the highest priority, which can perform actions for multiple steps, until it releases a token and a next AI-agent with the second-highest priority continues.

The prompt to the generative neural model may be issued using an Application Programming Interface (API) (block 310). In an aspect, a remote server hosts the generative neural model and the AI-agent is hosted by a separate computing device. The computing device and the remote server communicate through HTTP-based Representational State Transfer (REST) APIs. A REST API or web API is an API that conforms to the REST protocol. In the REST protocol, the remote server hosting the generative neural model contains a publicly-exposed endpoint having a defined request and response structure. The AI-agent issues web APIs containing the prompt to the remote server to instruct the large language model to perform the intended task and receives a response.

In another aspect, the AI-agent includes a generative neural model, such as a small language model (block 310). The AI-agent may use an API to invoke the generative neural model directly.

The AI-agent receives a response from the generative neural model which indicates the command needed to perform the task (block 310). The AI-agent sends the response to the conversation manager which logs the response in the conversation log for the task (block 310).

If the command within the response from the AI-agent indicates a stop command (block 312-yes), then the conversation manager terminates processing the task. Otherwise (block 312-no), the conversation manager continues processing the task.

The parser of the conversation manager extracts the command and related data received from the AI-agent. The parser checks to see if the command is truly a command or a natural language sentence. If the command is a true command, the parser checks the syntax to ensure that the arguments of the command are correct and if the AI-agent is allowed to initiate the command. Once these checks are successful, the parser invokes from the tool library the appropriate API to perform the command (block 314).

The invoked API engages the evaluation engine to build a secure execution environment for the command to run and to retrieve any data needed for the command (block 316). The command is executed in the secure execution environment or docker container (block 316). The evaluation engine transmits the status of the command execution and any output to the conversation engine (block 318). The conversation manager logs the status of the command execution and output to the conversation log (block 320).

The conversation manager continues processing the task until a threshold number of messages within the conversation has been reached (block 306) or an AI-agent indicates to stop (block 312). When the conversation manager has determined that the threshold number of messages has not been reached (block 306), the conversation manager then forwards the current state of the conversation to the AI-agent scheduler, which invokes an AI-agent to have the generative neural model determine if additional actions need to be performed (block 308). The response from the AI-agent is transmitted to the conversation manager (block 310) which invokes execution of the command through an appropriate software task API using the evaluation engine and docker engine (blocks 314, 316). The status of the execution of the follow-on task and its output is transmitted to the output engine of the conversation manager (block 318). If the threshold number of messages has not been reached (block 306), then the conversation manager proceeds with requesting the next follow-on task until a stop command is issued by an AI-agent to terminate the processing or the threshold number of messages has been reached.

### Unit Test Case Autonomous Processing

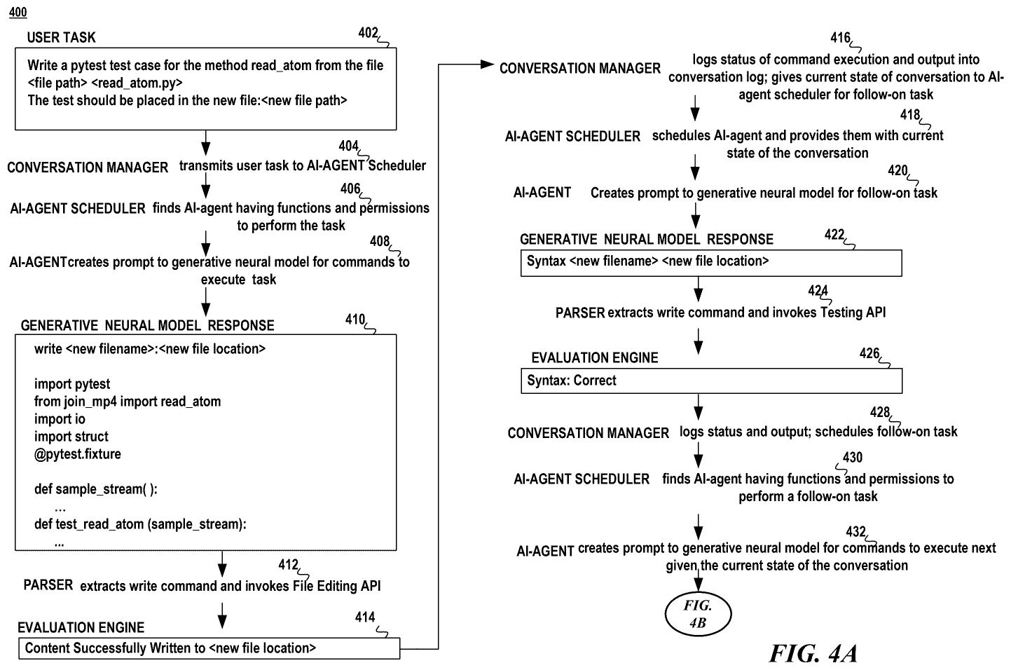

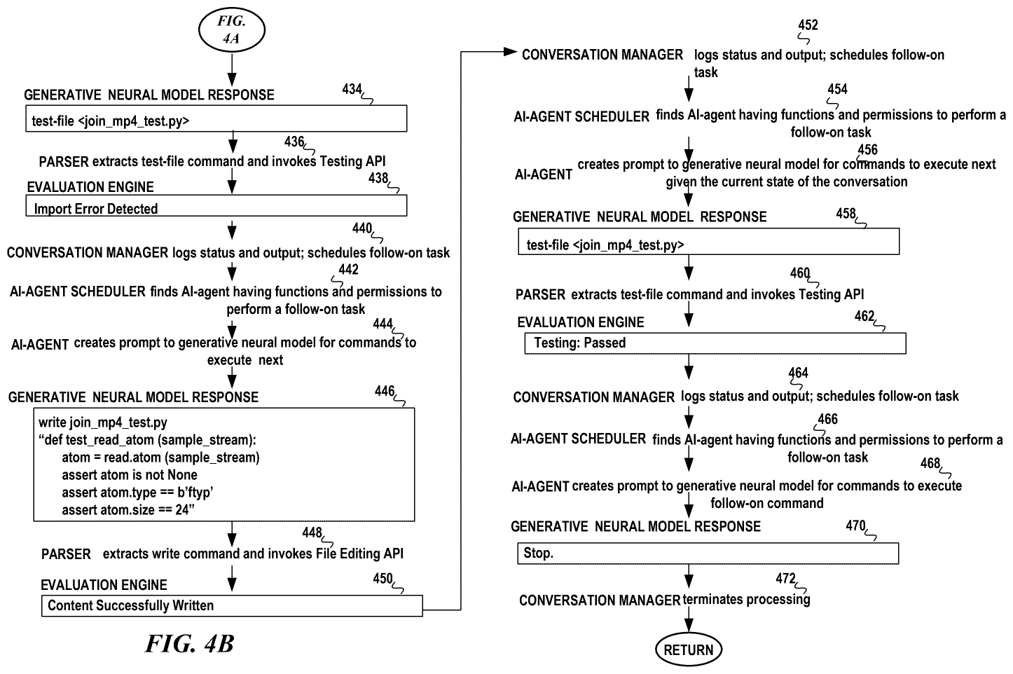

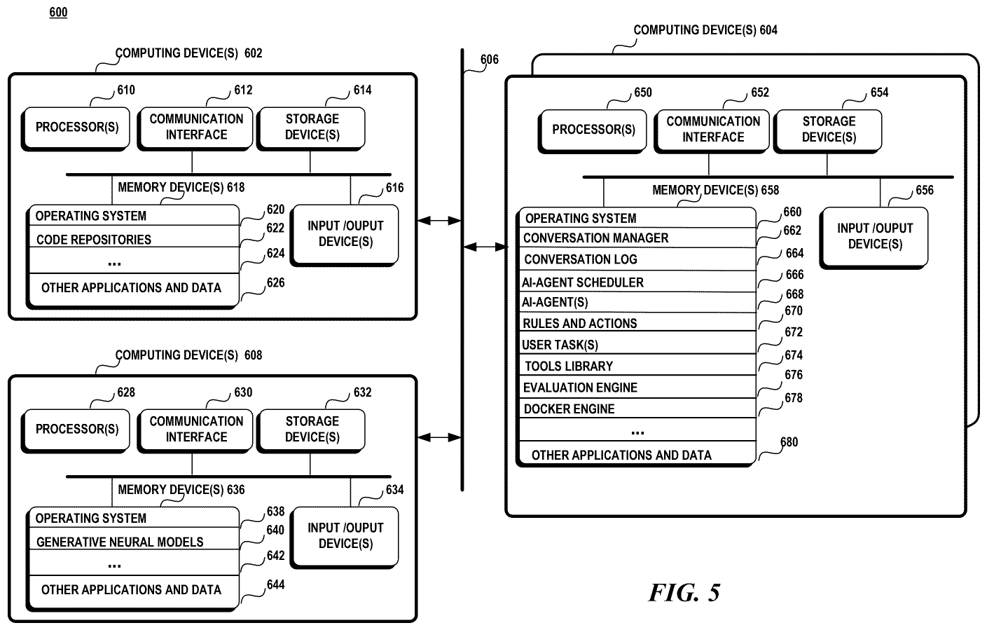

Attention now turns to an exemplary flow of the autonomous processing for the generation of a unit test case 400. Turning to FIGS. 4A and 4B, a user enters the task “Write a pytest test case for the method read_atom from the file <file path><read_atom.py>. The test case should be placed in the new file <new file path>” (step 402).

The conversation manager receives the task and creates a conversation with a single message which includes the user task (step 404). The conversation is transmitted to the AI-agent scheduler (step 404) which determines, based on the scheduling algorithm, which AI-agent should be invoked at this step (step 406).

The AI-agent scheduler transmits the conversation to the AI-agent (step 406). The AI-agent constructs a prompt including its system prompt, instructions, available actions, and the current state of the conversation, and sends this prompt to the generative neural model to generate the command needed to perform the task (step 408). The generative neural model responds with a pytest test case for the method read_atom and the command “write <new filename>:<new file location>” (step 410). The parser extracts the “write” command from the response and invokes the file editing API (step 412). The file edit API is executed by the evaluation engine and the output is the message “Content successfully written to <new file location>” (step 414).

The conversation manager logs the status and output from the evaluation engine (step 416) in the conversation log associated with the task along with the model response. The conversation manager then forwards the updated conversation for the next step to execute (step 416). The conversation manager transmits the conversation to the AI-agent scheduler (step 418) which transmits it to an appropriate AI-agent (step 420). The AI-agent creates a prompt to the generative neural model to determine a follow-on task (step 420). The prompt includes the AI-agent system prompt, instructions, available actions and the current state of the conversation (step 420). The generative neural model responds with the follow-on task “Syntax <new filename><new file location>” (step 422).

The parser extracts the “syntax” command and invokes the Testing API to perform a compilation of the newly-generated file (step 424). The evaluation engine performs the compilation and outputs the status “Syntax: Correct” (step 426).

The conversation manager receives the status and output and logs it into the conversation log for the task (step 428). The conversation manager interacts with the AI-agent scheduler for a follow-on task given the current state of the conversation (step 430). The AI-agent scheduler finds an appropriate AI-agent (step 432) and the AI-agent generates a prompt to the generative neural model for commands for a follow-on task given the current state of the conversation (step 432). The prompt includes the AI-agent's system prompt, instructions, available actions, and the current state of the conversation (step 432).

The generative neural model responds with the instruction to test the new file with “test-file <join_mp4_test.py>” (step 434). The parser extracts the command from the model's response and invokes the testing API to perform the test (step 436).

The evaluation engine performs the test and determines that there is an error in the test case (step 438). The conversation manager logs the error status and message into the conversation log and interacts with the AI-scheduler for an AI-agent to determine the follow-on task (step 440). The AI-scheduler finds an appropriate AI-agent (step 442) and the AI-agent creates a prompt to the generative neural model for the generative neural model to determine a follow-on task (step 444). The prompt includes the AI-agent's system prompt, instructions, available actions and the current state of the conversation (step 444).

The generative neural model responds with the corrected code for the test case for the read atom method and the command “write join_mp4_test.py” (step 446). The parser extracts the “write” command from the model's response and invokes the file editing API to perform the write (step 448). The evaluation engine performs the write command and outputs the status “Content Successfully Written” (step 450). The conversation manager logs the status message and interacts with the AI-scheduler to schedule an appropriate AI-agent (step 452). The AI-agent scheduler schedules an AI-agent (step 454) and the AI-agent generates a prompt for the generative neural model to determine the next follow-on task (step 456).

The generative neural model responds with the command to test the new file with the test case “test-file <join_mp4_test.py>” (step 458). The parser extracts the command from the model's response and invokes the testing API (step 460). The evaluation engine performs the test and outputs the message “Testing: Passed” (step 462). The conversation manager receives the status message and logs it in the conversation log (step 464). The conversation manager requests the AI-agent scheduler to schedule an AI-agent to determine the next follow-on task (step 464). The AI-scheduler finds the appropriate AI-agent having the functions and permissions to determine a follow-on task (step 466).

The AI-agent creates a prompt for the generative neural model to determine the next step to perform (step 468). The generative neural model determines that the task is completed and issues the stop command (step 470). The parser extracts the stop command from the model's response and instructs the conversation manager to cease processing the user task (step 472).

### Operating Environments

Attention now turns to a discussion of an exemplary operating environment 600. FIG. 6 illustrates an exemplary operating environment 600 having computing devices 602, 604, 608 communicatively coupled to a network 606. In one aspect, the conversation manager, AI-agent scheduler, AI agents, tools library, evaluation engine and docker container may be hosted on one computing device 604, the generative neural models hosted on another computing device 608 and the code repositories hosted on another computing device 602. In another aspect, all the components of the AI-driven software development system may be hosted on the same computing device. However, the aspects of the operating environment are not constrained to a particular configuration and the components of the AI-driven software development system may be configured as desired.

The computing devices 602, 604, 608 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 500 may be configured in a network environment, a distributed environment, a multi-processor environment, or a stand-alone computing device having access to remote or local storage devices.

A computing device 602, 604, 608 may include one or more processors 610, 628, 650, one or more communication interfaces 612, 630, 652 one or more storage devices 614, 632, 654, one or more input/output devices 616, 634, 656, and one or more memory devices 618, 636, 658. A processor 610, 628, 650 may be any commercially available or customized processor and may include dual microprocessors and multi-processor architectures. A communication interface 612, 630, 652 facilitates wired or wireless communications between the computing device 602, 604, 608 and other devices. A storage device 614, 632, 654 may be computer-readable medium that does not contain propagating signals, such as modulated data signals transmitted through a carrier wave. Examples of a storage device 614, 632, 654 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 614, 632, 654, in a computing device 602, 604, 608. The input/output devices 616, 634, 656 may include a keyboard, mouse, pen, voice input device, touch input device, display, speakers, printers, etc., and any combination thereof.

A memory device 618, 636, 658 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 618, 636, 658 may also include one or more external storage devices or remotely located storage devices that do not pertain to propagated signals, such as modulated data signals transmitted through a carrier wave.

The memory device 618, 636, 658 may contain instructions, components, and data. A component is a software program that performs a specific function and is otherwise known as a module, program, component, and/or application. The memory device 618 may include an operating system 620, various code repositories 622, and other applications and data 626. Memory device 636 may include an operating system 638, one or more generative neural models 640, and other applications and data 644. Memory device 658 may include an operating system 660, a conversation manager 662, a conversation log 664, an AI-agent scheduler 666, AI-agents 668, rules and actions 670, one or more user tasks 672, a tools library 674, an evaluation engine 676, a docker engine 678 and other applications and data 680.

The computing devices 602, 604, 608 may be communicatively coupled via a network 606. The network 606 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 606 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Technical Effect

Aspects of the subject matter disclosed pertain to the technical problem of autonomously performing a software engineering task. The technical features associated with addressing this problem include a conversation manager that generates conversations with AI-agents that utilize generative neural models to determine the commands needed to perform the software engineering task. The technical effect achieved is reduction of the computational resources used by a computing device to execute the software engineering task. The use of the generative neural models improves the performance of the software engineering task since the models are more efficient at analyzing various types of data to decide on the steps needed to perform a particular task.

### Conclusion

The techniques described herein are an improvement over prior solutions that required a user to determine the steps needed to perform a software engineering task and to manually execute each step. The prior solutions resulted in a significant latency in performing the software engineering task and consumed considerable computing resources and cost. For example, the prior solutions suggested a source code snippet to fix a software bug or to complete a partially-formed source code segment, without performing additional actions to ensure that the suggested source code snippet was syntactically-correct or viable for an intended task.

Furthermore, one of ordinary skill in the art understands that the techniques disclosed herein are inherently digital. The operations used to perform the autonomous processing including, without limitation, configuring the AI-agents, interacting with the generative neural models, managing the conversational flow, invoking the software task APIs in a secure execution environment are inherently digital. The human mind cannot interface directly with a CPU or network interface card, or other processor, or with RAM or other digital storage, to read or write the necessary data and perform the necessary operations disclosed herein.

The embodiments are also presumed to be capable of operating at scale, within tight timing constraints in production environments and in testing labs for production environments as opposed to being mere thought experiments. Hence, the human mind cannot perform the operations described herein in a timely manner and with the accuracy required for these intended uses.

A system is disclosed for autonomously processing a software engineering task. The system comprises: a processor; and a memory that stores a program that is configured to be executed by the processor. The program includes instructions to perform actions that: obtain, from user input, the software engineering task to perform without user intervention; create an initial message for a generative neural model to determine an initial command that performs a first step towards achieving the software engineering task; execute the initial command in a secure execution environment; obtain a status of the execution of the initial command from the execution of the initial command; log the initial message, the status of the execution of the initial command and the output of the initial command in a conversation for the software engineering task; continue creation of one or more follow-on messages with the generative neural model, wherein each of the one or more follow-on messages comprises a follow-on prompt for the generative neural model to determine a follow-on command to execute given a current state of the conversation for the software engineering task; execute each follow-on command from the one or more follow-on messages until a stop command is received as a next follow-on command, wherein each follow-on command is executed in a secure execution environment, wherein output of each execution of each follow-on command is logged in the conversation for the software engineering task; and upon receipt of a follow-on command indicating a stop command, terminate processing the software engineering task.

In an aspect, the program includes instructions to perform actions that: configure a plurality of AI-agents, wherein an AI-agent generates a prompt to a particular generative neural model for the particular generative neural model to determine the initial command or follow-on command, wherein the AI-agent is configured to perform one or more actions on a user's codebase.

In an aspect, the program includes instructions to perform actions that: configure each of the plurality of AI-agents with a system prompt, instructions, and one or more actions. In an aspect, the given prompt includes the system prompt, instructions, and the one or more actions of a select AI-agent. In an aspect, the configuration of the plurality of AI-agents is user-defined. In an aspect, wherein execute the initial command in a secure execution environment further comprises: obtain from a select one of the plurality of AI-agents, the initial command to execute; select an API configured to perform the initial command; and construct the secure execution environment to invoke the selected API.

In an aspect, the program includes instructions to perform actions that: obtain from the secure execution environment output from execution of the selected API; and create a follow-on message to a generative neural model for a follow-on command to continue processing the software engineering task. In an aspect, the program includes instructions to perform actions that: upon a number of the messages in the conversation exceeding a threshold, terminate processing the software engineering task.

A computer-implemented method is disclosed for autonomously processing a software engineering task. The computer-implemented comprises: obtaining, via user input, the software engineering task to process autonomously without user intervention; generating a conversation with one or more AI-agents and a codebase environment to perform operations to process the software engineering task, wherein the one or more AI-agents generate a prompt to a generative neural model for the generative neural model to determine a command to execute to process the software engineering task, wherein the codebase environment executes the command determined by the generative neural model in a secure execution environment with access to a user codebase, wherein the conversation comprises a plurality of messages transmitted to and received from the one or more AI-agents and transmitted to and received from the codebase environment; determining, at each of a plurality of iterations, the command to process the software engineering task, wherein at each iteration of the plurality of iterations, the command is generated by the generative neural model given the prompt, wherein the prompt comprises a current state of the conversation at a respective iteration; executing, at each iteration of the plurality of iterations, the command determined by the generative neural model until a stop command is received as a next command to execute; and upon receipt of a stop command, terminating processing of the software engineering task.

In an aspect, at each iteration a particular AI-agent is selected to generate a respective prompt to obtain a respective command that further processes the software engineering task. In an aspect, the computer-implemented method further comprises logging, at each iteration, the prompt to the generative neural model, the executed command, and output of the executed command in the conversation. In an aspect, the computer-implemented method further comprises: configuring, via user input, the one or more AI-agents with one or more actions, wherein an action is an operation to be performed on the user codebase.

In an aspect, the computer-implemented method, further comprises enabling, via user input, the one or more actions configured to the one or more AI-agents. In an aspect, the computer-implemented method of claim 12, further comprises selecting one of the one or more AI-agents having actions configured for the software engineering task to obtain the command from the generative neural model.

A hardware storage device having stored thereon computer executable instructions that are structured to be executable by a processor of a computing device to thereby cause the computing device to perform actions that: obtain a software engineering task to perform on a user codebase without user intervention; create an initial message for a generative neural model to generate an initial command that executes the software engineering task; execute the initial command in a secure execution environment; obtain a status of the execution of the initial command; log the initial message, the status of the execution of the initial command and the initial command in a conversation for the software engineering task; continue creation of one or more follow-on messages with the generative neural model, wherein each of the one or more follow-on messages comprises a follow-on prompt for the generative neural model to determine a follow-on command to execute given a current state of the conversation; execute each follow-on command from the one or more follow-on messages until a stop command is received as a next follow-on command, wherein each follow-on command is executed in a secure execution environment, wherein output of each execution of each follow-on command is logged in the conversation for the software engineering task; and upon receipt of a follow-on command indicating a stop command, terminate processing the software engineering task.

In an aspect, the hardware storage device has stored thereon computer executable instructions that are structured to be executable by a processor of a computing device to thereby cause the computing device to perform actions that: configure a plurality of AI-agents, wherein an AI-agent generates a prompt to a particular generative neural model for the particular generative neural model to determine the initial command or follow-on command, wherein the AI-agent is configured to perform one or more actions on a user codebase.

In an aspect, the hardware storage device has stored thereon computer executable instructions that are structured to be executable by a processor of a computing device to thereby cause the computing device to perform actions that: configure each of the plurality of AI-agents with a system prompt, instructions, and one or more actions.

In an aspect, wherein execute each follow-on command from the one or more follow-on messages until a stop command is received further comprises: obtain from a select one of the plurality of AI-agents, the initial command to execute; select an API configured to perform the initial command; and construct the secure execution environment to invoke the selected API.

In an aspect, wherein execute each follow-on command from the one or more follow-on messages until a stop command is received further comprises: obtain from the secure execution environment output from execution of the selected API; and create a follow-on message to a generative neural model for a follow-on command to continue processing the software engineering task. In an aspect, wherein a software engineering task comprises code generation, test code generation, code completion, software bug classification, software bug repair code, software vulnerability detection, or software vulnerability repair code.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

What is claimed:

1. A system for autonomously processing a software engineering task, comprising:
a processor; and
a memory that stores a program that is configured to be executed by the processor, the program includes instructions to perform actions that:
obtain, from user input, the software engineering task to perform without user intervention;
create an initial message for a generative neural model to determine an initial command that performs a first step towards achieving the software engineering task;
execute the initial command in a secure execution environment;
obtain a status of the execution of the initial command from the execution of the initial command;
log the initial message, the status of the execution of the initial command and the output of the initial command in a conversation for the software engineering task;
continue creation of one or more follow-on messages with the generative neural model, wherein each of the one or more follow-on messages comprises a follow-on prompt for the generative neural model to determine a follow-on command to execute given a current state of the conversation for the software engineering task;
execute each follow-on command from the one or more follow-on messages until a stop command is received as a next follow-on command, wherein each follow-on command is executed in a secure execution environment, wherein output of each execution of each follow-on command is logged in the conversation for the software engineering task; and
upon receipt of a follow-on command indicating a stop command, terminate processing the software engineering task.

2. The system of claim 1, wherein the program includes instructions to perform actions that:
configure a plurality of AI-agents, wherein an AI-agent generates a prompt to a particular generative neural model for the particular generative neural model to determine the initial command or follow-on command, wherein the AI-agent is configured to perform one or more actions on a user's codebase.

3. The system of claim 2, wherein the program includes instructions to perform actions that:
configure each of the plurality of AI-agents with a system prompt, instructions, and one or more actions.

4. The system of claim 3, wherein the given prompt includes the system prompt, instructions, and the one or more actions of a select AI-agent.

5. The system of claim 2, wherein the configuration of the plurality of AI-agents is user-defined.

6. The system of claim 2, wherein execute the initial command in a secure execution environment further comprises:
obtain from a select one of the plurality of AI-agents, the initial command to execute;
select an API configured to perform the initial command; and
construct the secure execution environment to invoke the selected API.

7. The system of claim 6, wherein the program includes instructions to perform actions that:
obtain from the secure execution environment output from execution of the selected API; and
create a follow-on message to a generative neural model for a follow-on command to continue processing the software engineering task.

8. The system of claim 1, wherein the program includes instructions to perform actions that:
upon a number of the messages in the conversation exceeding a threshold, terminate processing the software engineering task.

9. A computer-implemented method for autonomously processing a software engineering task, comprising:
obtaining, via user input, the software engineering task to process autonomously without user intervention;
generating a conversation with one or more AI-agents and a codebase environment to perform operations to process the software engineering task, wherein the one or more AI-agents generate a prompt to a generative neural model for the generative neural model to determine a command to execute to process the software engineering task, wherein the codebase environment executes the command determined by the generative neural model in a secure execution environment with access to a user codebase, wherein the conversation comprises a plurality of messages transmitted to and received from the one or more AI-agents and transmitted to and received from the codebase environment;
determining, at each of a plurality of iterations, the command to process the software engineering task, wherein at each iteration of the plurality of iterations, the command is generated by the generative neural model given the prompt, wherein the prompt comprises a current state of the conversation at a respective iteration;
executing, at each iteration of the plurality of iterations, the command determined by the generative neural model until a stop command is received as a next command to execute; and
upon receipt of a stop command, terminating processing of the software engineering task.

10. The computer-implemented method of claim 9, wherein at each iteration a particular AI-agent is selected to generate a respective prompt to obtain a respective command that further processes the software engineering task.

11. The computer-implemented method of claim 9, further comprising:
logging, at each iteration, the prompt to the generative neural model, the executed command, and output of the executed command in the conversation.

12. The computer-implemented method of claim 9, further comprising:
configuring, via user input, the one or more AI-agents with one or more actions, wherein an action is an operation to be performed on the user codebase.

13. The computer-implemented method of claim 12, further comprising:
enabling, via user input, the one or more actions configured to the one or more AI-agents.

14. The computer-implemented method of claim 12, further comprising:
selecting one of the one or more AI-agents having actions configured for the software engineering task to obtain the command from the generative neural model.

15. A hardware storage device having stored thereon computer executable instructions that are structured to be executable by a processor of a computing device to thereby cause the computing device to perform actions that:
obtain a software engineering task to perform on a user codebase without user intervention;
create an initial message for a generative neural model to generate an initial command that executes the software engineering task;
execute the initial command in a secure execution environment;
obtain a status of the execution of the initial command;
log the initial message, the status of the execution of the initial command and the initial command in a conversation for the software engineering task;
continue creation of one or more follow-on messages with the generative neural model, wherein each of the one or more follow-on messages comprises a follow-on prompt for the generative neural model to determine a follow-on command to execute given a current state of the conversation;
execute each follow-on command from the one or more follow-on messages until a stop command is received as a next follow-on command, wherein each follow-on command is executed in a secure execution environment, wherein output of each execution of each follow-on command is logged in the conversation for the software engineering task; and
upon receipt of a follow-on command indicating a stop command, terminate processing the software engineering task.

16. The hardware storage device of claim 15, having stored thereon computer executable instructions that are structured to be executable by a processor of a computing device to thereby cause the computing device to perform actions that:
configure a plurality of AI-agents, wherein an AI-agent generates a prompt to a particular generative neural model for the particular generative neural model to determine the initial command or follow-on command, wherein the AI-agent is configured to perform one or more actions on a user codebase.

17. The hardware storage device of claim 15, having stored thereon computer executable instructions that are structured to be executable by a processor of a computing device to thereby cause the computing device to perform actions that:
configure each of the plurality of AI-agents with a system prompt, instructions, and one or more actions.

18. The hardware storage device of claim 15, wherein execute each follow-on command from the one or more follow-on messages until a stop command is received further comprises:
obtain from a select one of the plurality of AI-agents, the initial command to execute;
select an API configured to perform the initial command; and
construct the secure execution environment to invoke the selected API.

19. The hardware storage device of claim 18, wherein execute each follow-on command from the one or more follow-on messages until a stop command is received further comprises:
obtain from the secure execution environment output from execution of the selected API; and
create a follow-on message to a generative neural model for a follow-on command to continue processing the software engineering task.

20. The hardware storage device of claim 18, wherein a software engineering task comprises code generation, test code generation, code completion, software bug classification, software bug repair code, software vulnerability detection, or software vulnerability repair code.
